(19) United States
(12) Patent Application Publication
(10) Pub. No.: US 2017/0105091 A1
(43) Pub. Date: Apr. 13, 2017

(54) PRESENCE TRACKING METHOD

(71) Applicant: EDEVICE, Mérignac (FR)

(72) Inventors: Stefan GONNET, Merignac (FR); Michaël FREUDMANN, Ra'anana (IL)

(73) Assignee: EDEVICE, Mérignac (FR)

(21) Appl. No.: 15/129,285

(22) PCT Filed: Mar. 23, 2015
(86) PCT No.: PCT/FR2015/050722

§ 371 Date: Sep. 26, 2016

(30) Foreign Application Priority Data
Mar. 27, 2014 (FR) 1452625

(51) Int. Cl. H04W 4/02; G08B 21/22; H04W 4/00

(52) U.S. Cl. CPC H04W 4/02; H04W 4/008; G08B 21/22

(57) ABSTRACT

A presence tracking method includes the steps of detecting the presence of one or more agents in the vicinity of at least one predefined geolocated point by verifying the establishment of a short-distance communication between one or more mobile communication terminals of one or more agents with one or more fixed devices, associated and located at the predefined geolocated point, of informing one or more remote servers about the presence or not of agents in the vicinity of the predefined geolocated point by transmitting an acknowledgement signal to one or more remote servers at regular intervals; and, after the occurrence of one or more predetermined events, carrying out one or more operations in response to the event. The present disclosure also relates to a system for implementing the method.

### CROSS-REFERENCE TO RELATED APPLICATIONS

This application is a National Phase Entry of International Patent Application Serial Number PCT/FR2015/050722, filed on Mar. 23, 2015, which claims priority to French Patent Application Serial No. 14/52625, filed on Mar. 27, 2014, both of which are incorporated by reference herein.

### TECHNICAL FIELD

The present invention relates to a method and system for tracking the presence of a person in the vicinity of a predefined geolocated point.

### BACKGROUND

Tracking the presence of one or more persons may be useful for generating an appropriate response to this presence or to the tracking of this presence in many fields, such as for example the configuration of access to a hazardous or limited-access zone, including in the context of a system for monitoring this type of zone, but also in home automation or personal services. This is because personal services, whether housekeeping, ironing, gardening, child minding or assistance for seniors, are developing more and more. The services are normally offered by private companies or associations that work at the homes of persons having recourse to these services.

For this type of work in particular, it is generally difficult first to ensure that the service provider is indeed at the home of the person and secondly to have a reliable account of the hours provided. Normally, the service providers note on a sheet of paper, or an attendance log, the start and end times of the service, or make this recording via a telephone server by contacting the server by telephone at the start of the service or at the end of the service, the server counting the hours of presence without however checking on the actual presence of the service provider throughout the hours indicated. However, these methods have the drawback of proving difficult to implement, but also difficult in the management of the programmes and the processing of information concerning compliance with these programmes, when a multitude of different service providers are working.

In addition, and with regard in particular to compliance with time ranges determined in advance for a service, the absence of the service provider is generally discovered only subsequently, without being able to make it possible to provide a solution of replacement for the absent service provider. Likewise, changes in the programme are very often discovered by the service provider on site, without any means of anticipating such changes.

### SUMMARY

The present invention aims to provide a method and a system for implementing the method that do not have the drawbacks of the prior art. The present invention aims to provide a solution applicable to all types of provision of personal services. The present invention also aims to provide a solution that combines ease of implementation, speed, flexibility and reliability.

The present invention relates to a presence monitoring method comprising the steps of detecting the presence of one or more agents, in the vicinity of at least one predefined geolocated point, by verifying the establishment of a short-distance communication between one or more mobile communication terminals of one or more agents with one or more fixed devices, associated and located at the predefined geolocated point, of informing one or more distant servers of the presence or not of the agent or agents in the vicinity of the predefined geolocated point by the transmission, at regular intervals, to one or more distant servers, of an acknowledgement signal, and, following the occurrence of one or more predetermined events, of performing one or more operations in response to the event or events.

According to preferred embodiments of the invention, the method comprises at least one, or any suitable combination, of the following features:
detection of the presence of one or more agents, in the vicinity of at least one predefined geolocated point, is carried out by searching, in the vicinity of the predefined geolocated point, for unique identifiers, broadcast by the mobile communication terminal or terminals, and by comparing the unique identifiers found with those recorded as being the identifiers of the agent or agents associated with the predefined geolocated point,
in the case of absence of acknowledgement signal, the method further comprises a step of activating means for the geolocation of the mobile communication terminal or terminals of the agent or agents and of comparing the results of this geolocation with the predefined geolocated point, and then a step of sending an alert message, to one or more mobile communication terminals of one or more agents.
the method comprises the activation of the verification of the establishment of a short-distance communication between the controller or controllers and the mobile communication terminal or terminals of the agent or agents, and/or the performance of the operation or operations, in response to the predetermined event or events, taking place according to predefined time ranges,
the method comprises at least one step of processing the information relating to the presence of one or more agents in the vicinity of a predefined geolocated point.

The present invention also relates to a system for implementing the method according to the invention, the system comprising:
one or more mobile communication terminals of one of more agents comprising short-distance communication means able to communicate with one or more fixed devices, associated and located at a predefined geolocated point, and optionally geolocation means,
one or more fixed devices, associated and located at a predefined geolocated point, comprising communication means able to communicate with the mobile communication terminal or terminals and with one or more remote servers,
one or more remote servers comprising communication means able to communicate with the mobile communication terminal or terminals and the fixed device or devices,
means for verifying the establishment of a short-distance communication between the mobile communication terminal or terminals and the device or devices,
means for informing the remote server or servers of the presence or not of the agent or agents in the vicinity of the predefined geolocated point using means for transmitting an acknowledgement signal at regular intervals to one or more remote servers,
means for implementing one or more operations in response to the occurrence of one or more predetermined events.

According to preferred embodiments of the invention, the system according to the invention comprises at least one, or any appropriate combination, of the following features:
the means for verifying the establishment of a short-distance communication between the mobile communication terminal or terminals and the device or devices using unique identifiers, broadcast by the mobile communication terminal or terminals, and means for comparing the unique identifiers found with those recorded as being the identifiers of the agent or agents associated with said predefined geolocated point,
the system comprises means for activating the geolocation means of the mobile communication terminal or terminals of the agent or agents and means for comparing the results of this geolocation with the predefined geolocated point, and means for sending an alert message to one or more mobile communication terminals of one or more of the agents,
the system comprises a diary, or one or more predefined time ranges, for activation of the means for verifying the establishment of a short-distance communication between the mobile communication terminal or terminals and the fixed device or devices and/or for performing the operation or operations, in response to the predetermined event or events,
the system comprises means for processing information relating to the presence of one or more agents in the vicinity of a predefined geolocated point.

### DETAILED DESCRIPTION

The presence-tracking method according to the invention comprises a first step of detecting the presence of one or more agents, for example service providers, in the vicinity of at least one predefined geolocated point. This presence detection is done by means of one or more mobile communication terminals belonging the agent or agents, and one or more controller devices associated with the predefined geolocated point. Preferably, this detection comprises the verification of the establishment of a short-distance communication, and optionally of the communication, between the controller or controllers and the mobile communication terminal or terminals of the agent or agents.

Establishing a short-distance communication makes it possible to define a detection space, which for example covers the home of a person using the services of the agent or agents. This short-distance communication is done wireless, preferably using radio waves, such as for example Wi-Fi, Bluetooth and/or DECT.

Preferably, the presence of one or more agents is detected uniquely by means of a search for unique identifiers, linked to each agent, and broadcast by the mobile communication terminal or terminals of the agent or agents and comparing the unique identifiers found with those recorded for, or in, the controller or controllers as being the identifiers of the agent or agents who are to work. Preferably, the identifiers are information concerning the agent or agents and/or information concerning the mobile communication terminal or terminals, such as for example a MAC (media access control) address or a telephone number. Preferably, the method comprises a prior step of providing and recording, in, or for, the controller or controllers of a geolocated point, unique identifiers of each agent, and associating these identifiers with the geolocated point in question. Preferably, the method may comprise a prior step of associating the controller or controllers with at least one predefined geolocated point. The method further comprises the steps of informing the remote server or servers of the presence or not of the agent or agents in the vicinity of the predefined geolocated point by the transmission of an acknowledgement signal at regular intervals to at least one remote server in order to inform the server of the establishment of the short-distance communication, and optionally of the communication, between the mobile communication terminal or terminals of the agent or agents and the controller or controllers associated with a determined point, and then, following the occurrence of one or more predetermined events, performing one or more operations in response to the event or said events.

If the predefined event is the absence of an acknowledgement signal, and therefore a failure to establish the short-distance communication, the method may further comprise the activation of means for the geolocation of the mobile communication terminal or terminals of the agent or agents and comparison of the results of this geolocation with the predefined geolocated point. If it appears that the agent or agents are not in the vicinity of the predefined geolocated point, the method may provide a step of the sending of a message by the server or servers to the agent or agents on their mobile communication terminals so that they go to the predefined geolocated point or the sending of a message to one or more other agents so that they go to the predefined geolocated point. If it appears that the agent or agents are in the vicinity of the predefined geolocated point, the method may provide a step of the sending of a message by the server or servers to the agent or agents on their mobile communication terminals in order to solve the problem of matching between the mobile communication terminal or terminals and the controller or controllers. In this case, the agent or agents may attempt to fix the controller or controllers and/or the mobile communication terminal or terminals, for example by restarting them, by making new matches, or checking and/or changing their electrical supply.

If the predefined event is the absence of an acknowledgement signal after a first acknowledgement signal has been communicated, and therefore that an establishment of communication has taken place and has been recorded, by the controller or controllers and/or the remote server or servers, possibly an absence of signal appearing after a predetermined period, the method may comprise a step of activating the geolocation means of the mobile communication terminal or terminals of the agent or agents and comparing the results of this geolocation with the predefined geolocated point. If it appears that the agent or agents are not in the vicinity of the predefined geolocated point, the method may provide a step of recording the event, then corresponding to the end of the presence of the agent or agents at the predefined geolocated point, and of recording the period, in units of time, that has elapsed between the establishment of the communication with the controller or controllers and its interruption, which then corresponds to the duration of the presence of the agent or agents at the predefined geolocated point. If it appears that the agent or agents are in the vicinity of the predefined geolocated point, the method may provide a step of the sending of a message by the server or servers to the agent or agents on their mobile communication terminals in order to solve the problem of matching between the mobile communication terminal or terminals and the controller or controllers. In this case, the agent or agents may attempt to fix the controller or controllers and/or the mobile communication terminal or terminals, for example by restarting them, making new matches, or checking and/or changing their electrical supply.

If the predefined event is a failure to establish communication between the controller or controllers and the remote server or servers, the method may provide a step of the sending of a message by the server or servers to the agent or agents on their mobile communication terminals, in the vicinity or not of the predefined geolocated point, in order to solve the problem, for example by restarting the controller or controllers and/or checking and/or changing their electrical supply. The method may further comprise the activation of the verification of the establishment of a short-distance communication between the controller or controllers and the mobile communication terminal or terminals of the agent or agents, and optionally of the periodic communication, at regular intervals, with at least one remote server, of the acknowledgement signal according to predefined time ranges, for example according to a diary of the presence of the agent or agents in the vicinity of the predefined geolocated point. The method may also comprise a step in which the operation or operations, in response to the predetermined event or events, are performed according to one or more predefined time ranges, for example according to a diary for the presence of the agent or agents in the vicinity of the predefined geolocated point.

Preferably, the method comprises a prior step of recording and storing the time range or ranges, or diary, in the controller or controllers or in the remote server or servers, advantageously of associating the time range or ranges, or diary, with a predefined geolocated point, optionally also with one or more agents. If the event or events take place in a time range in which said event or events are supposed to occur, the method may provide for the performance of one or other of the predetermined operations, or optionally other predetermined operations. If the event is the absence of the acknowledgement signal at the start of a defined time range, or ceases before the end of said defined time range, the method may provide for the sending of a message by the server or servers to the agent or agents on their mobile communication terminals so that, respectively, the agent or agents arrive, or remain, at the predefined geolocated point. Preferably, the message comprises the communication of the time range or ranges in question. If the event is the sending of the acknowledgement signal at the start of a defined time range, or ceases after the end of said defined time range, the method may provide for the sending of a message by the server or servers to the agent or agents on their mobile communication terminals in order to inform them that the predetermined diary has been followed.

The method may also comprise a step in which the remote server or servers communicate, to the agent or agents, the predefined time range or ranges, or diary, for their presence in the vicinity of the predefined geolocated point. Preferably, the method further comprises one or more steps of processing information concerning the presence of one or more agents in the vicinity of a predefined geolocated point.

The method according to the invention can be implemented in many fields, such as for example the tracking of the presence of persons in hazardous zones, or in limited-access zones, in the field of surveillance or home automation, but also in the field of personal services, in general terms in all fields in which the presence or tracking of the presence of the persons may give rise to the performance of one or more actions or operations in response to one or more events in relation to this presence or presence tracking. These operations may for example be counting human presence in a designated space or volume or the activation of one or more appliances in a given space, for example the starting up of air conditioning or lighting, or invoicing the number of service minutes actually fulfilled. The system for tracking the presence of one or more agents in the vicinity of at least predefined geolocated point comprises means for detecting the presence of the agent or agents in the vicinity of the predefined geolocated point, comprising one or more mobile communication terminals able to communicate with at least one long-distance communication network, for example a computer and/or telephone network, the mobile terminal or terminals comprising computerised and/or telephonic long-distance communication means, short-distance communication means and optionally geolocation means.

Preferably, the mobile communication terminal or terminals are mobile telephones, or smartphones, communicating via a cellular telephone network, of the GSM type, and comprising Wi-Fi, Bluetooth or DECT connectivity and optionally comprising a GPS chip. Preferably, the mobile communication terminal or terminals comprise unique identifiers, associated with the agent or agents to which the mobile communication terminal or terminals belong. Advantageously, the identifiers are information concerning the agent or agents and/or information concerning the mobile communication terminal or terminals, such as for example a MAC (media access control) address or a telephone number.

The system further comprises one or more controllers, fixed devices, disposed at a predefined geolocated point, and associated with this point. They comprise communication means able to communicate with at least one mobile communication terminal of at least one agent, preferably short-distance communication means. Preferably, these means are also able to communicate with one or more remote servers, preferably they are communication means able to communicate with a communication network, advantageously a computer and/or telephone network.

The short-distance communication means allow communication in transmission and reception in a delimited and determined radius, thus defining a detection space. Preferably, the detection space covers the home of a person using the services of the agent or agents. These short-distance communication means comprise Wi-Fi, Bluetooth and/or DECT means.

The system comprises means for verifying the establishment of a short-distance communication, and optionally of the communication, between the controller or controllers and the mobile communication terminal or terminals of the agent or agents and further comprises means for informing the remote server or servers of the presence or not of the agent or agents in the vicinity of the predefined geolocated point. These means comprise means for the periodic communication, with at least one remote server, of an acknowledgement signal informing the remote server or servers of the establishment of the short-distance communication, and optionally of the communication, between the mobile communication terminal or terminals of the agent or agents and the controller or controllers associated with the predefined geolocated point. Preferably, the means for verifying the establishment of a short-distance communication between the controller or controllers and the mobile communication terminal or terminals of the agent or agents comprise the execution of a comparison of the unique identifiers associated with, or information concerning, the agent or agents to whom the mobile communication terminal or terminals belong, advantageously a MAC (media access control) address or a telephone number, with the identifier or information recorded and consultable in a database on the controller or controllers and/or on one or more remote servers.

The system further comprises means for performing one or more operations in response to the occurrence of one or more events. The system according to the invention, the means for performing the operation or operations, and/or the remote server or servers, cooperate with or use geolocation means of the mobile communication terminal or terminals of the agent or agents, means for comparing the results of this geolocation with the predefined geolocated point, and means for sending one or more messages to one or more mobile communication terminals. Preferably, the system comprises means for creating and/or managing said messages.

The message or messages are of various types according to circumstances. In the case of absence of an acquisition signal and a geolocation of the agent or agents distant from the predefined geolocated point, the message may comprise an alert requesting one or more agents to go to the predefined geolocated point. In the case of the absence of an acquisition signal and a geolocation of the agent or agents in the vicinity of the predefined geolocated point, the message may comprise an alert requesting the agent or agents to solve the problem of matching between the mobile communication terminal or terminals and the controller or controllers. In the case of the absence of an acquisition signal after a first acknowledgement signal has been communicated and of a geolocation of the agent or agents in the vicinity of the predefined geolocated point, the message may comprise an alert requesting the agent or agents to solve the problem of matching between the mobile communication terminal or terminals and the controller or controllers. In the case of the absence of communication between the controller or controllers and the remote server or servers and of a geolocation of the agent or agents in the vicinity of the predefined geolocated point, the message may comprise an alert requesting the agent or agents to solve the communication problem. In the case of the absence of an acquisition signal after a first acknowledgement signal has been communicated and of a geolocation of the agent or agents distant from the predefined geolocated point, the system comprises means for recording the absence of a signal, then corresponding to the end of the presence of the agent or agents at the predefined geolocated point, and of recording the period, in units of time, that has elapsed between the establishment of the communication with the controller or controllers and its interruption, which then corresponds to the duration of the presence of the agent or agents at the predefined geolocated point.

Preferably, the system comprises a diary, or one or more predefined time ranges, for activation of the means for verifying the establishment of a short-distance communication between the controller or controllers and the mobile communication terminal or terminals of the agent or agents, and/or of the periodic communication, at regular intervals, with at least one remote server, of the acknowledgement signal. Preferably, the means for performing the operation or operations in response to the occurrence of one or more events are implemented according to one or more predefined time ranges, for example according to a diary for the presence of the agent or agents in the vicinity of the predefined geolocated point.

The system comprises one or more remote servers. The remote server or servers comprise long-distance communication means able to communicate, in reception and transmission, with one or more controllers and one or more mobile communication terminals, via a long-distance communication network, for example a computer and/or telephone network. The remote server or servers comprise means for receiving information coming from the controller or controllers concerning the presence or not of the agent or agents in the vicinity of the predefined geolocated point.

Preferably, the remote server or servers comprise means for receiving and recording at least one acknowledgement signal coming from one or more controllers. Preferably, the remote server or servers comprise means for creating, managing and sending, to one or more mobile communication terminals, one or more messages. Preferably, the remote server or servers comprise means of association, and of recording the association, between one or more agents and one or more controllers or a predefined geolocated point.

Preferably, the remote server or servers comprise means of association, and of recording the association, between one or more agents and one or more controllers or a predefined geolocated point. Preferably, the server or servers and/or the controller or controllers comprise means for recording and storing one or more time ranges, or one or more diaries. Preferably, the system comprises means for communicating one or more time ranges, or one or more diaries, to the mobile communication terminal or terminals of one or more agents. Preferably, the system, the remote server or servers or the controller or controllers comprise means for performing one or more operations in response to the occurrence of one or more events. Preferably, the system, or the remote server or servers, comprises or comprise means for processing information on tracking of the agent or agents.

1. A presence tracking method comprising the following steps:
detection of the presence of one or more agents, in a vicinity of at least one predefined geolocated point, by verifying an establishment of a short-distance communication between one or more mobile communication terminals of the one or more agents with one or more fixed devices, associated and located at the predefined geolocated point;
information to one or more remote servers on the presence or not of the agent or agents in the vicinity of the predefined geolocated point by a transmission of an acknowledgement signal to one or more remote servers at regular intervals; and
following an occurrence of one or more predetermined events, a performance of one or more operations in response to the event or events.

2. The method according to claim 1, wherein the detection of the presence of the one or more agents, in the vicinity of the at least one predefined geolocated point, is performed by searching, in the vicinity of the predefined geolocated point, for unique identifiers, broadcast by the mobile communication terminal or terminals, and by comparing the unique identifiers found with those recorded as being the identifiers of the agent or agents associated with the predefined geolocated point.

3. The method according to claim 1, further comprising, in a case of an absence of an acknowledgement signal, a step of activating geolocation of the mobile communication terminal or terminals of the agent or agents and comparing the results of this geolocation with the predefined geolocated point, and then a step of sending an alert message to one or more mobile communication terminals of one or more of the agents.

4. The method according to claim 1, further comprising activation of the verification of the establishment of the short-distance communication between a controller or controllers and the mobile communication terminal or terminals of the agent or agents, and/or the performance of the operation or operations, in response to the predetermined event or events, taking place according to predefined time ranges.

5. The method according to claim 1, further comprising processing the information concerning the presence of the one or more agents in the vicinity of the predefined geolocated point.

6. A presence tracking system comprising:
one or more mobile communication terminals of one of more agents comprising a short-distance communicator adapted to communicate with one or more fixed devices, associated and located at a predefined geolocated point;
the one or more fixed devices, associated and located at the predefined geolocated point, comprising a communicator adapted to communicate with a mobile communication terminal or terminals and with one or more remote servers;
one or more remote servers comprising a communicator adapted to communicate with the mobile communication terminal or terminals and the fixed device or devices;
a comparison verifying the establishment of a short-distance communication between the mobile communication terminal or terminals and the device or devices;
an identifier informing said remote server or servers of the presence or not of the agent or agents in the vicinity of the predefined geolocated point using a transmitter operably transmitting an acknowledgement signal at regular intervals to one or more remote servers; and
implementing one or more operations in response to the occurrence of one or more predetermined events.

7. The system according to claim 6, wherein the comparison verifying the establishment of the short-distance communication between the mobile communication terminal or terminals and the device or devices, uses unique identifiers, broadcast by the mobile communication terminal or terminals, and compares the unique identifiers found with those recorded as being the identifiers of the agent or agents associated with the predefined geolocated point.

8. The system according to claim 6, further comprising activating a geolocation feature of the mobile communication terminal or terminals of the agent or agents and comparing the results of this geolocation feature with the predefined geolocated point, and for sending an alert message to one or more mobile communication terminals of one or more of the agents.

9. The system according to claim 6, further comprising a diary, or one or more predefined time ranges, for activation of the comparison verifying the establishment of the short-distance communication between the mobile communication terminal or terminals and the fixed device or devices and/or performing the operation or operations, in response to the predetermined event or events.

10. The system according to claim 6, further comprising a controller processing the information concerning the presence of one or more agents in the vicinity of the predefined geolocated point.
